(19) United States
(12) Patent Application Publication
(10) Pub. No.: US 2025/0297851 A1
(43) Pub. Date: Sep. 25, 2025

(54) POSITION DETECTION SYSTEM USING LASER LIGHT INTERFEROMETRY

(71) Applicant: VDL ENABLING TECHNOLOGIES GROUP B.V., EINDHOVEN (NL)

(72) Inventor: Johannes Hubertus Antonius VAN DE RIJDT, EINDHOVEN (NL)

(21) Appl. No.: 18/998,096

(22) PCT Filed: Jul. 20, 2023
(86) PCT No.: PCT/NL2023/050391

§ 371 Date: Jan. 23, 2025

(30) Foreign Application Priority Data
Jul. 27, 2022 (NL) 2032613

(51) Int. Cl. G01B 11/00

(52) U.S. Cl. CPC G01B 11/005

(57) ABSTRACT

The invention relates to a position detection system using laser light interferometry for measuring the positions and displacements of an object relative to and within an XYZ system of coordinates, the system comprising a frame and a holder comprising a mounting surface for the object, the mounting surface being oriented in the XY plane of the XYZ system of coordinates, wherein the holder is structured to be displaced at least between a first operational position and a second operational position within the XY plane relative to the frame. Such laser light interferometry detection systems can be implemented, for example, in semiconductor and integrated circuit manufacturing processes.

### TECHNICAL FIELD

The invention relates to a position detection system using laser light interferometry for measuring the positions and displacements of an object relative to and within an XYZ system of coordinates, the system comprising a frame and a holder comprising a mounting surface for the object, the mounting surface being oriented in the XY plane of the XYZ system of coordinates, wherein the holder is structured to be displaced at least between a first operational position and a second operational position within the XY plane relative to the frame. Such laser light interferometry detection systems can be implemented, for example, in semiconductor and integrated circuit manufacturing processes.

### BACKGROUND OF THE INVENTION

Applications requiring high precision positioning and displacements, for example wafer substrates undergoing semiconductor and integrated circuit manufacturing processes, implement laser light interferometry detection systems. Multiple measuring mirrors and laser light beams directed to and from those mirrors are used for determining the positions and the displacements of an object within an XYZ system of coordinates based on laser light interferometry.

Present day laser light interferometry detection systems allow for multiple degrees of freedom (DOF) measurements within such XYZ system of coordinates, however the accuracy of these measurements are limited and adversely affect the efficiency of the overall process in which laser light interferometry detection system is implemented.

For example, for displacement distances or strokes, which are longer than the dimensions of the holder multiple DOF measurements might be lost. Furthermore, presently known applications implement additional measuring mirrors positioned within the working space, thus occupying work volume in the direct vicinity where semiconductor and integrated circuit manufacturing processes are performed.

However, in such applications where these additional measuring mirrors are positioned within the working space in order to cover large displacement distances or strokes of the holder through the position detection system the interferometer sensors are fixed to the frame of the system. Accordingly, the measurement area that the interferometer sensors can cover are limited to the size of the mirrors mounted to the holder, which is to be displaced between a first operational position and a second operational position in the system work space.

If larger strokes (stroke means the distance between the first operational position and the second operational position in the system work space) are required of the holder compared to the size of the mirrors mounted thereon, the interferometry signals are lost. Loss of signal means that the system should find an accurate reference again since the IFM is only an incremental measurement. Accordingly, multiple interferometer sensors and six DoF zeroing sensors need to be implemented, resulting is a more expensive and complex laser light interferometry detection system. However, implementing multiple sensors requires renewed calculations in order to determine the absolute reference point of the holder within the system working space, further resulting in an expensive system. Furthermore, losing an accurate reference point for the holder within the system working space and the repeated recalculation of the reference point reduces the output of the system and is a continued risk for accuracy errors.

This problem occurs typically in laser light interferometry applications where is a measurement station (or first operational position) where the sample object on the holder is measured and a process station (or second operational position) where the sample object on the holder is processed. During the displacement of the holder with the sample object from its measurement position towards its processing position an accurate measurement system is required in particular when the stroke of the stage at least in one direction (that is the distance between the first and the second operational positions) is larger than the size of (the mirrors on) the holder.

The present disclosure aims to provide a solution for the above identified problem and to present a position detection system using laser light interferometry with a reduced and simplified optics, hence having reduced constructional dimensions and improved accuracy as to the measurement of a position and/or displacement of a holder within an XYZ system of coordinates.

### SUMMARY OF THE INVENTION

According to a first aspect of the disclosure, a position detection system using laser light interferometry for measuring the positions and displacements of an object relative to and within an XYZ system of coordinates is proposed, the system comprising a frame; a holder comprising a mounting surface for the object, the mounting surface being oriented in the XY plane of the XYZ system of coordinates, wherein the holder is structured to be displaced at least between a first operational position and a second operational position along a first coordinate axis of the XY plane relative to the frame; several measuring mirrors as well as a plurality of optical devices, each optical device structured to emit and direct a respective laser light beam to and from a respective measuring mirror and structured to detect and convert at least part of the respective laser light beams reflected by the respective measuring mirrors into electric measuring signals, the electric measuring signals comprising at least information as to the X, Y and Z position of the holder, wherein, for measuring the position of the holder relative to a first coordinate axis of the XY plane, at least one first axis optical device is structured to be displaced with the holder between the first operational position and the second operational position along the first coordinate axis of the XY plane and is structured to emit and direct a respective first laser light beam parallel to the XY plane and perpendicular to the first coordinate axis to and from a first mirror face of a respective first axis measuring mirror extending along the first coordinate axis beyond both the first operational position and the second operational position.

With the displacement of the optical device together with the holder during its movement from the first operational position and the second operational position along an coordinate axis of the XY plane, the accurate reference point for the holder within the system working space is never lost, even when the displacement stroke of the holder between the first and the second operational position is larger than the size of (the mirrors on) the holder itself.

In an example, the at least one first axis optical device is mounted to the holder.

In a preferred alternative, the at least one first axis optical device is mounted to a mount, which mount is structured to be displaced between the first operational position and the second operational position along the first coordinate axis relative to the frame. Accordingly, in both examples, the accurate reference point for the holder within the system working space (the XYZ system of coordinates) is never lost, as the position of the holder is measured in real time with no risk of losing the position of reference point.

In particular, the first axis measuring mirror is mounted to the frame, whereas in an alternative example the first axis measuring mirror is composed of at least two first axis measuring submirrors, the latter ascertaining an improved accuracy as to the position measurement of the holder relative to the first coordinate axis withing the system working space.

In a further advantageous example, the mount is provided with a recess for receiving the first axis measuring mirror. Accordingly, when a Michelson interferometer type sensor is used, each direction can be measured with a single source and detector in the sensor.

Furthermore, in order to obtain a differential position measurement of the position of the holder relative to the first coordinate axis of the XY plane, the holder may comprise a first axis holder measuring mirror having a first mirror face positioned perpendicular to the XY plane.

In a preferred example, the coordinated displacement of both the holder and the first axis optical device is a synchronous displacement.

Next, in a further advantageous example, wherein in a simultaneous manner the Z-position of the holder can be measured with the same laser light interferometry system, the at least one first axis optical device is also structured to emit and direct a respective further laser light beam under an angle α relative to the XY plane to and from a further mirror face of the first axis measuring mirror.

Similarly, the measurement of the Z-position of the holder wherein is likewise improved as the at least one first axis optical device is structured to emit and direct the respective further laser light beam under the angle α relative to the XY plane to and from a further mirror face of the first axis holder measuring mirror.

In the above two examples, the further mirror face of the first axis measuring mirror or the first axis holder measuring mirror is orientated at the angle α relative to the first mirror face of the first axis measuring mirror or the first axis holder measuring mirror.

Thus, implementing an additional angled laser light beam and a composite (holder) measuring mirror composed of a first mirror face positioned perpendicular to the XY plane and a further mirror face orientated at the angle α relative to the first mirror face, the optics of the position detection system can be simplified significantly as any additional Z measuring mirror can be obviated. Particularly, this results in less occupied work volume in the direct vicinity where semiconductor and integrated circuit manufacturing processes.

Depending on the constructional dimension of the holder being used and the desired accuracy of the measurements, the angle α of the at least one angled Z laser light beam relative to the XY plane is in the range between 5°-45°, in particular in the range of 5°-25°, more in particular in the range of 5°-15°, and more in particular the angle α=7°.

In a further detail, the first axis holder measuring mirror may comprise a third mirror face positioned perpendicular to the XY plane and adjoining the further mirror face opposite the first mirror face. The third mirror face may serve as an additional first axis measuring mirror for an additional first axis laser light beam and can accordingly be used for measuring all further six degrees of freedom of the holder, in particular a rotation or tilting thereof around the X, Y or Z axis.

In an further example of the disclosure, for measuring the position of the holder relative to the second coordinate axis of the XY plane, the system comprises a further second axis optical device structured to emit and direct a respective laser light beam parallel to the XY plane and parallel to the first coordinate axis to and from at least one second measuring mirror positioned perpendicular to the first coordinate axis of the XY plane and positioned beyond the first operational position or the second operational position.

In particular a further second measuring mirror is positioned perpendicular to the first coordinate axis of the XY plane and positioned between the first operational position or the second operational position. This further second measuring mirror can be effectively used as a reference mirror for each Degree of Freedom to be measured.

### BRIEF DESCRIPTION OF THE DRAWINGS

The invention will now be discussed with reference to the drawings, which show in:

FIGS. 1A-1C an example of a position detection system using laser light interferometry according to the prior art;

FIGS. 2A-2C an example of a position detection system using laser light interferometry according to the disclosure;

FIG. 3 a further example of a position detection system using laser light interferometry according to the disclosure;

FIGS. 4A-4B yet another example of a position detection system using laser light interferometry according to the disclosure;

FIGS. 5A-5C further details of examples of a position detection system using laser light interferometry according to the disclosure;

FIGS. 6A-6C further details of examples of a position detection system using laser light interferometry according to the disclosure;

FIGS. 7A-7B further details of examples of a position detection system using laser light interferometry according to the disclosure;

FIGS. 8A-8D further details of examples of a position detection system using laser light interferometry according to the disclosure;

FIG. 9 yet another example of a position detection system using laser light interferometry according to the disclosure.

### DETAILED DESCRIPTION OF THE INVENTION

For a proper understanding of the invention, in the detailed description below corresponding elements or parts of the invention will be denoted with identical reference numerals in the drawings.

It is known in the prior art, that applications requiring high precision positioning and displacements, for example wafer substrates undergoing semiconductor and integrated circuit manufacturing processes, may implement laser light interferometry detection systems. Multiple measuring mirrors and laser light beams directed to and from those mirrors are used for determining the positions and the displacements of an object within an XYZ system of coordinates based on laser light interferometry.

Present day laser light interferometry detection systems allow for multiple degrees of freedom (DOF) measurements within such XYZ system of coordinates, however, experience some limitations.

For example, for displacement distances or strokes, which are longer than the dimensions of the holder multiple DOF measurements might be lost. Furthermore, presently known applications implement additional measuring mirrors positioned within the working space, thus occupying work volume in the direct vicinity where semiconductor and integrated circuit manufacturing processes are performed.

If larger strokes (stroke means the distance between the first operational position and the second operational position in the system work space) are required of the holder compared to the size of the mirrors mounted thereon, the interferometry signals are lost. Loss of signal means that the system should find an accurate reference again since the IFM is only an incremental measurement. Accordingly, multiple interferometer sensors and six DoF zeroing sensors need to be implemented, resulting is a more expensive and complex laser light interferometry detection system. However, implementing multiple sensors requires renewed calculations in order to determine the absolute reference point of the holder within the system working space, further resulting in an expensive system. Furthermore, losing an accurate reference point for the holder within the system working space and the repeated recalculation of the reference point reduces the output of the system and is a continued risk for accuracy errors.

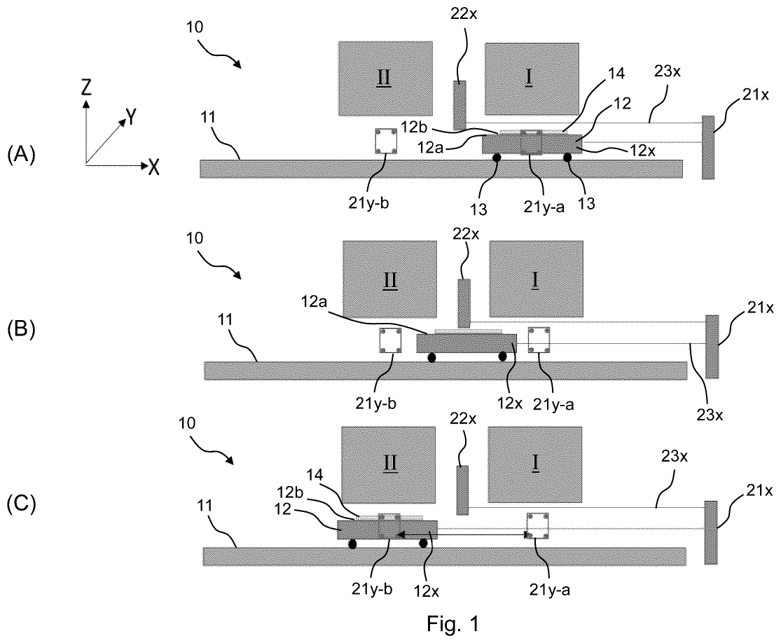

An example of such laser light interferometry detection system according to the state of the art is depicted in FIGS. 1A-1C and is denoted with reference numeral 10. Such position detection system 10 using laser light interferometry is capable of measuring the positions and displacements of an object relative to and within an XYZ system of coordinates. In an example, the object 14 may be a wafer substrate undergoing semiconductor and integrated circuit manufacturing processes for the manufacturing of semiconductor components.

Usually, the system 10 implements a frame 11 in which a holder 12 is movable accommodated. The displacement of the holder 12 is achieved using suitable holder displacement means 13, which displace the holder 12 along a ground surface (solid world)/within the frame 11 of the system 10. The holder 12 is capable of holding the object (wafer substrate) 14. As shown in FIGS. 1A-1C, holder 12 encompasses a mounting surface 12a for the object 14, and preferably such object 14 is accommodated within a mounting space 12b machined or provided in the mounting surface 12a. The mounting surface 12a of the holder 12 is oriented, preferably parallel, in the XY plane of a XYZ system of coordinates, its orientation being depicted at the left side of FIG. 1A.

The XYZ system of coordinates as depicted at the left side of FIG. 1A is composed of three coordinate axis X, Y, Z, which define a coordinate orientation of the holder 12 within the working space of the system 10.

The above identified problem of losing the accurate reference point for the holder 12 within the system working space occurs typically in laser light interferometry applications where the holder 12 (with the sample object 14) is displaced between a measurement station I (or first operational position) where the sample object 14 on the holder 12 is measured and a process station II (or second operational position) where the sample object 14 on the holder 12 is processed. During the displacement of the holder 12 with the sample object 14 from its measurement position I towards its processing position II an accurate measurement system is required in particular when the stroke of the stage at least in one direction (that is the distance between the first and the second operational positions) is larger than the size of (the mirrors on) the holder.

In the example of FIGS. 1A-1C the stroke of the stage (displacement of the holder 12 from position I towards position II) is depicted as a displacement along the X-coordinate axis of the XY plane relative to the frame 11.

For monitoring the displacement and more in particular the accurate position of the holder 12 through the system working space (hence within the XYZ system of coordinates) of the system 10 according to the state of the art, multiple optical devices are implemented, each optical device structured to emit and direct an laser light beam to and from a respective laser light interferometry measuring mirror. The reflected laser light beams are converted into electric measuring signals, and the electric measuring signals contain information as to the actual X, Y and Z position of the holder 12 (containing an object 14 mounted in the mounting space 12b on the mounting surface 12a) within the system working space (XYZ system of coordinates).

Using a suitable signal processing unit (not shown) the emitted and reflected laser light beams are used to calculate the X, Y and Z position using laser light interferometry.

As an example, second axis optical device 21x (mounted to the frame 11) emits a laser light beam 23x parallel to the first (X) coordinate axis, which beam 23x is reflected back and forth by a corresponding measuring mirror 22x mounted in frame 11 and as mirror 12x mounted to the holder 12. The reflected beam 23x provides information on the actual X position of the holder 12 relative to the Y coordinate axis. Within the XY plane the second axis optical device 21x determines the X position or the distance of the holder relative to the Y coordinate axis.

Likewise, as shown in FIGS. 1A-1C, two or more optical devices 21y-a and 21y-b are mounted in the frame 11 along the X coordinate axis and emit a laser light beam 23y (not shown, but the propagation direction of the laser beam 23y is considered pointing out of the plane of FIGS. 1A-1C) towards the holder 12 (parallel to the Y axis). The holder 12 contains a measuring mirror on its side surface which reflects the laser beam 23y back to the respective optical devices 21y-a and 21y-b. The reflected beam 23y provides information on the actual Y position of the holder 12 within the XY plane relative to the X coordinate axis. Herewith any (minimal) Y displacement of the holder 12 in the direction of the Y coordinate axis (hence relative to the X coordinate axis) can be effectively measured.

However, in the application of FIGS. 1A-1C, the measurement area that the optical devices (interferometer sensors) 21y-a and 21y-b cover, is limited by the size of the mirrors mounted to the holder 12. In FIG. 1A, the holder 12 is in the first operational position I and within the detection of the first optical device 21y-a. However, during its displacement from the first operational position I towards the second operational position II (FIGS. 1B and 1C) the holder 12 will leave the detection area of the first optical device 21y-a, yet will not be entering the detection area of the second optical device 21y-b.

This situation is shown in FIG. 1B, which situation the interferometry signals are lost. The loss of signal means that the system 10 should find an accurate reference again since the interferometry measurements are only incremental measurements. This would require multiple interferometer sensors (optical devices), resulting is a more expensive and complex laser light interferometry detection system.

The present disclosure aims to provide a solution for the above identified problem and to present a position detection system using laser light interferometry with a reduced and simplified optics, hence having reduced constructional dimensions and improved accuracy as to the measurement of a position and/or displacement of a holder within an XYZ system of coordinates.

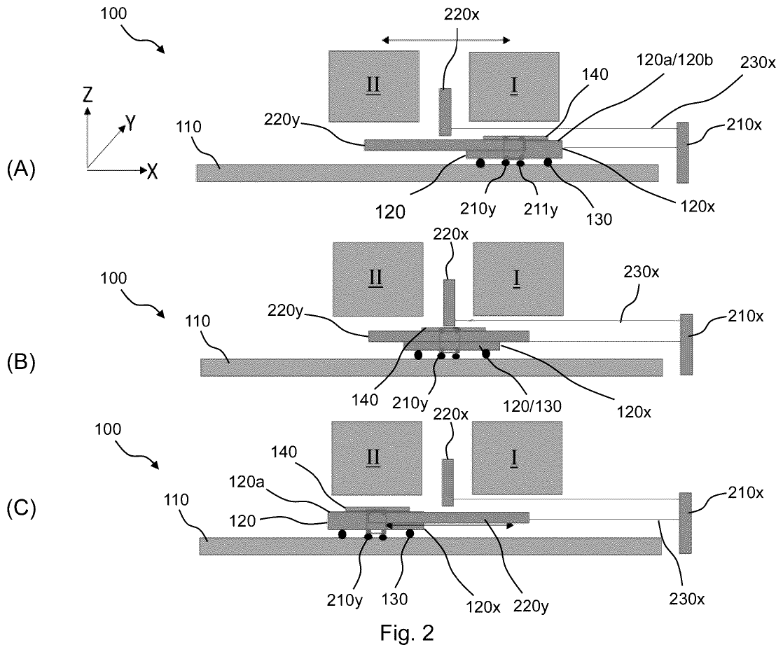

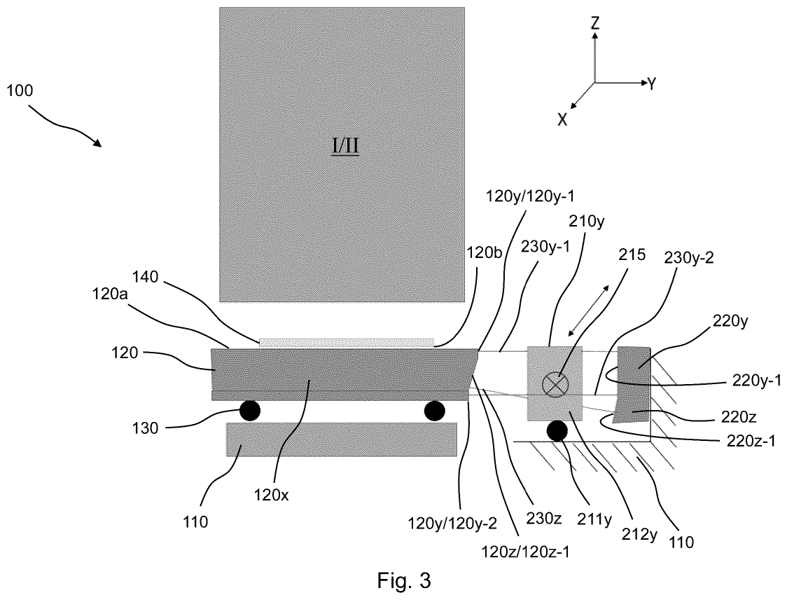

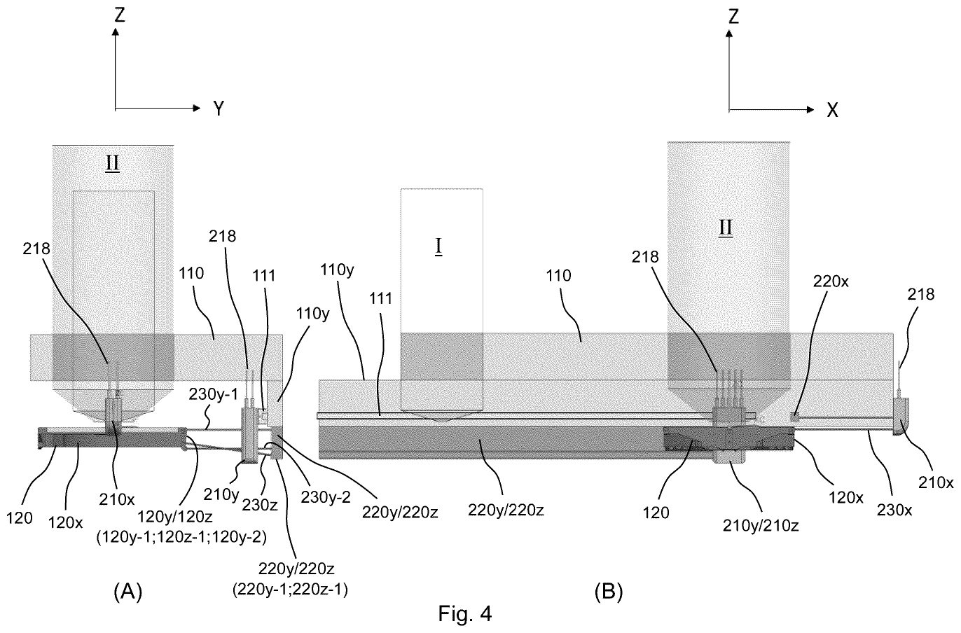

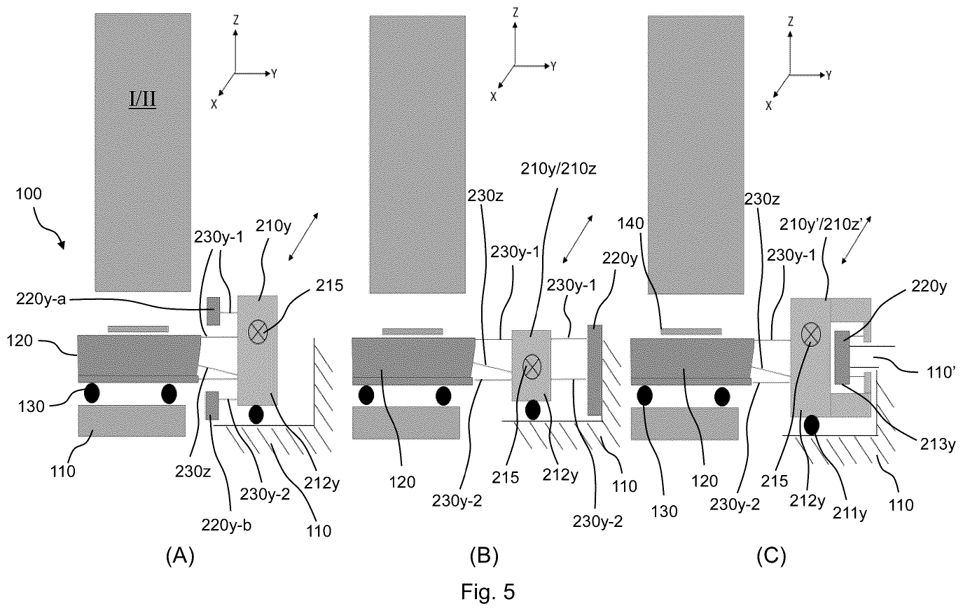

An example of such position detection system using laser light interferometry according to the disclosure is depicted in FIGS. 2A-2C with further details shown in FIG. 3, in FIGS. 4A-4C and in FIGS. 5A-5D. In the Figures, the position detection system is denoted with reference numeral 100 and is also capable of measuring the positions and displacements of the object 12 relative to and within the XYZ system of coordinates.

The the position detection system 100 implements a frame 110 in which a holder 120 is movable accommodated. The displacement of the holder 120 is achieved using suitable holder displacement means 130, which displace the holder 120 along a ground surface (solid world)/within the frame 110 of the system 100, in a similar fashion as with the position detection system 10 depicted in FIGS. 1A-1C. The holder 120 is capable of holding the object (wafer substrate) 140. Likewise, holder 120 encompasses a mounting surface 120a for the object 140, and preferably such object 140 is accommodated within a mounting space 120b machined or provided in the mounting surface 120a. The mounting surface 120a of the holder 120 is oriented, preferably parallel, in the XY plane of the XYZ system of coordinates, its orientation being depicted at the left side of FIG. 2A.

The position of the holder 120 within the the XYZ system of coordinates is measured using laser interferometry using measuring mirrors as well as optical devices, wherein each optical device is structured to emit and direct a respective laser light beam to and from a respective measuring mirror. At least part of the respective laser light beams reflected by the respective measuring mirrors are converted into electric measuring signals which contain at least representative information as to the X, Y and Z position of the holder 120.

In order to obviate the problem of losing interferometry signals as shown in FIG. 1B, wherein the holder according to the state of the art is no longer within the measurement area of any of the optical devices, in the system 100 according to the disclosure, for measuring the Y position of the holder 120 relative to the first coordinate axis (denoted as the X axis) of the XY plane, at least one first axis optical device 210y is structured to be displaced together with the holder 120 between the first operational position I and the second operational position II along the first (X) coordinate axis of the XY plane.

The at least one first axis optical device 210y emits and directs a respective first laser light beam 230y (230y-1 and/or 230y-2) using a laser device 215, see FIG. 3, parallel to the XY plane (and parallel to the Y coordinate axis) and perpendicular to the first coordinate axis X to and from a first mirror face 220y-1 of a respective first axis measuring mirror 220y. The first axis measuring mirror 220y has a significant longitudinal dimension and extends along the first coordinate axis X beyond both the first operational position I and the second operational position II, see FIG. 2B.

With the displacement of the optical device 210y together with the holder 120 during its movement from the first operational position I and the second operational position II along a first coordinate axis (here the X axis) of the XY plane, the accurate reference point for the holder 120 within the system working space is never lost, even when the displacement stroke of the holder 120 between the first and the second operational position is larger than the size of (the mirrors on) the holder 120 itself.

In an example, the at least one first axis optical device 210y is mounted to the holder 120 and is thus displaced together with the holder 120 by its holder displacement means 130.

In a preferred alternative, which is shown in FIG. 3 and in more alternative details in FIGS. 5A-5C, the at least one first axis optical device 210y (210y′) is mounted to a mount or housing 212y, which mount (housing) 212y accommodates the laser device 215. The mount 212y is also structured to be displaced between the first operational position I and the second operational position II along the first coordinate axis X relative to the frame 110 using suitable device displacement means 211y. Accordingly, in both examples, the accurate reference point for the holder 120 within the system working space (the XYZ system of coordinates) is never lost, as the Y position of the holder 120 is measured relative to the first coordinate axis X in real time with no risk of losing the position of reference point.

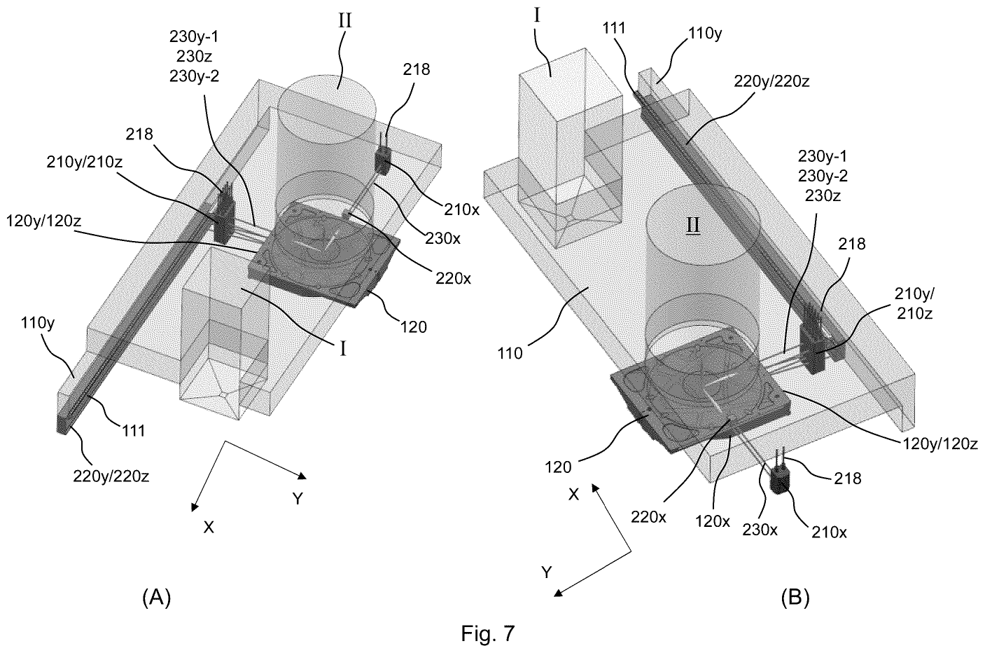

In another advantageous example depicted in FIGS. 4A-4B, 6A-6C and 7A-7B the frame 110 is provided with a guide part 110y to which a guide rail 111 is mounted.

The guide rail 111 accommodates the mount or housing 212y of the first axis optical device 210y.

In a particular example as shown in the Figures, the first axis measuring mirror 220y is mounted to the frame 110 as shown in FIGS. 3 and 5A-5C, directly or alternatively mounted to the guide part 110y as shown in FIGS. 4A-4B, 6A-6C and 7A-7B. Alternatively, the first axis measuring mirror 220y may be composed of at least two first axis measuring submirrors, denoted in FIG. 5A with reference numerals 230y-1 and 230y-2, the latter ascertaining an improved accuracy as to the Y position measurement of the holder 120 (in particular any skewed or rotated orientation) relative to the first coordinate axis X withing the system working space.

As shown in FIG. 5C, the mount 212y of the alternative, second example of the optical device 210y′ is provided with a recess 213y in which recess the first axis measuring mirror 220y is received. In this example, the the first axis measuring mirror 220y is mounted to a support part 110′ of the frame/solid world 110. When implementing a Michelson interferometer the differential mirror should be measured in the same direction (as shown in FIG. 5A). The advantage of the example shown in FIG. 5C compared to the example of FIG. 5A is that the measurement (error) is far less sensitive to rotations (Rx) of the optical device 210y′ as both laser beams are in line.

As shown in FIGS. 3, 4A-4B, 5A-5C, 6A-6C and 7A-7B, in order to obtain a differential position measurement of the Y position of the holder 120 relative to the first coordinate axis (X) of the XY plane, the holder 120 may comprise a first axis holder measuring mirror 120y having a first mirror face 120y-1 positioned perpendicular to the XY plane, which plane is formed by the mounting surface 120a. Accordingly, the laser light beam 230y-1 as emitted by the laser device 215 of the at least one first axis optical device 210y impinges perpendicular on the holder measuring mirror 120y (perpendicular to the X axis/parallel to the Y axis) and is reflected in an opposite direction back to the first axis optical device 210y.

It is noted that the displacement of the optical device 210y together with the displacement of the holder 120 along a coordinate axis (here the X axis) of the XY plane should be coordinated in such manner that the optical device 210y maintains within “optical sight” of the first axis holder measuring mirror 120y of the holder 120 and the elongated first axis measuring mirror 220y on the frame 110. Accordingly, the first laser light beam 230y (230y-1 and/or 230y-2) as emitted by the laser device 215 of the optical device 210y is reflected back constantly during the coordinated displacement of both the holder 120 and the optical device 210y along the X coordinate axis and provides constant information as to the actual differential position measurement of the Y position of the holder 120 relative to the first coordinate axis (X) of the XY plane.

In a preferred example, the coordinated displacement of both the holder 120 and the optical device 210y is a synchronous displacement.

In a simultaneous manner the Z-position of the holder 120 can be measured with the same laser light interferometry system. In this example, the at least one first axis optical device 210y emits and directs a respective further laser light beam 230z which is generated by the same or another laser device 215 in the mount 212y. The further laser light beam 230z is emitted under an angle α relative to the XY plane (the mounting surface 120a) to and from a further mirror face 220z-1 of the first axis measuring mirror 220y.

The first axis measuring mirror 220y accordingly exhibits a dual optical functionality as its composite mirror surface 220y-1/220z-1 can be used for laser light interferometric measurements of both the Y position as well as the Z position of the holder 120 within the system working space (XYZ coordinate system). Accordingly, because of this dual optical functionality the first axis measuring mirror will also be denoted by the reference numeral 220y/220z.

The measurement of the Z-position of the holder 120 is improved as the at least one first axis optical device 210y also emits and directs the respective further laser light beam 230z under the angle α relative to the XY plane (the mounting surface 120a) to and from a further mirror face 120z-1 of the first axis holder measuring mirror 120y. The first axis holder measuring mirror 120y accordingly exhibits a dual optical functionality as its composite mirror surface 120y-1/120z-1 can be used for laser light interferometric measurements of both the Y position as well as the Z position of the holder 120 within the system working space (XYZ coordinate system). Accordingly, because of this dual optical functionality the first axis holder measuring mirror will also be denoted by the reference numeral 120y/120z.

Both the further mirror face 220z-1/120z-1 of the first axis measuring mirror 210y/210z or the first axis holder measuring mirror 120y/120z is orientated at the angle α relative to the first mirror face 220y-1/120y-1 of the first axis measuring mirror 210y or the first axis holder measuring mirror 120y.

The advantage of the use of a single mirror reflection surface mounted to the holder 120 allows for the measurement of all degree of freedom measurements, in particular the Y and Z degrees of freedom (both e.g. in mm). As shown in FIG. 3 and FIGS. 4A-4B and 5A-5C, a single, composite YZ measuring mirror 120y/120z (220y/220z) is used on both the holder 120 and in the frame 110. Both composite mirrors are formed of a first axis measuring mirror 120y (220y), with the first mirror face 120y-1 (220y-1) positioned perpendicular to the XY plane/mounting surface 120a of the holder 120 and the Z measuring mirror 120z (220z) with the angled further mirror face 120z-1 (220z-1). This allows for a further reduction of the constructional dimensions of particularly the holder 120, in particular its thickness or Z-dimension. The same applies for the dimension of the measuring mirror 220y/220z mounted in the frame 110.

In the examples shown, the first axis measuring mirror/first mirror face 120y/120y-1 is positioned closest/closer to the mounting surface 120a than the adjoining angled Z measuring mirror/further mirror face 120z/120z-1.

The Z position or direction of the holder 120 relative to the XYZ system of coordinates is determined or measured by a differential measurement of the laser light interferometry measurement on the angled mirror surface 120z-1 combined with the laser light interferometry measurement on the straight mirror surface 120y-1 and the angled mirror surface 220z-1 combined with the laser light interferometry measurement on the straight mirror surface 220y-1.

Depending on the constructional dimension of the holder 120 and the desired accuracy of the measurements, the angle α of the at least one angled Z laser light beam 230z relative to the XY plane is in the range between 5°-45°, in particular in the range of 5°-25°, more in particular in the range of 5°-15°, and more in particular the angle α=7°.

In a further detail as shown in FIG. 3A as well as in FIGS. 4A-4B, and 5A-5C, the first axis holder measuring mirror 120y-120z comprises a third mirror face 120y-2 positioned perpendicular to the XY plane and adjoining the further mirror face 120z-1 opposite the first mirror face 120y-1. The third mirror face 120y-2 serves as an additional first axis measuring mirror 120y for an additional first axis laser light beam 230y-2 and is used for measuring a further degree of freedom of the holder 120, in particular a rotation or tilting Rx thereof around the first coordinate axis X.

Any rotation Rx around the X-axis can be determined or measured by a differential measurement of the laser light interferometry measurement on the reflected laser light beam 230y-1 via the first mirror face 120y-1 and the laser light interferometry measurement on the reflected laser light beam 230y-2 via the third mirror face 120y-2. Note, both the first mirror face 120y-1 and the third mirror face 120y-2 have a perpendicular orientation to the XY plane/mounting surface 120a and are parallel to each other, with the further, angled mirror surface 120z-1 positioned between the two mirror faces 120y-1 and 120y-2.

To be less sensitive for rotations of the optical device 210y the most preferred solution for an accurate measurement is to ascertain that the laser light beam 230y-1 (230y-2) towards the holder 120/the first axis holder measuring mirror 120y and the laser light beam 230y-1 (230y-2) towards the measuring mirror 220y are in line (coincide) with each other.

In alternative examples of the first axis holder measuring mirror 120y-120z, the functionality of the Y mirror face 120y-1 (first mirror face) and the Y mirror face 120y-2 (third mirror face) can be reversed, with the third mirror face 120y-2 (for measuring the rotation around the X axis) being positioned closest to the mounting surface 120a and the first mirror face 120y-1 (for measuring the rotation around the X axis together with the third mirror face and for measuring the Y position/displacement and for measuring the Z position/displacement together with the further mirror face 120z-1) being positioned furthest away from the mounting surface 120a.

Additionally, in FIG. 3, the thickness of the further mirror face 120z-1 (e.g. the angled holder measuring mirror 120z) decreases (becomes smaller or thinner) in a direction away from the mounting surface 120a or the thickness progresses towards the mounting surface 120a. However, in another example of the holder measuring mirror 120-y/120z, the angled mirror face 120z-1 can be reversed, such that the thickness thereof decreases (becomes smaller or thinner) in a direction towards the mounting surface 120a.

For measuring the position of the holder 120 relative to the second coordinate axis Y of the XY plane, hence for determining the X position relative to the Y axis, the system 100 is provided with a second axis optical device 210x emitting and directing a laser light beam 230x parallel to the XY plane and parallel to the first coordinate axis X to and from at least one measuring mirror 220x positioned perpendicular to the first coordinate axis X of the XY plane and positioned beyond the first operational position I or the second operational position II. Optionally, a further second measuring mirror 220x is positioned perpendicular to the first coordinate axis X of the XY plane and positioned between the first operational position I and the second operational position II. This further second measuring mirror 220x can be effectively used as a reference mirror for each degree of freedom to be measured.

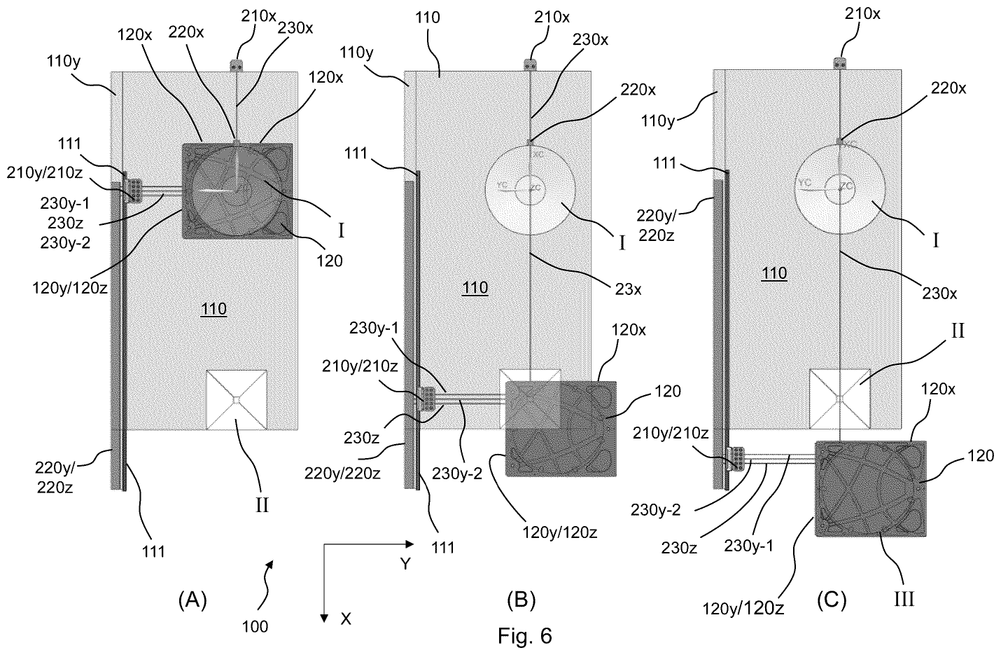

FIGS. 6A and 6B depict the situations of the holder 120 during its movement from the first operational position I (FIG. 6A) and the second operational position II (6B) within the YX plane and along the X coordinate axis whilst in FIG. 6C the situation is shown wherein the holder 120 is displaced towards a further, third operational position III, which can be an loading/off-loading position for loading/off-loading of the object 140 from the holder 120. During its movements between operational positions I, II and III the optical device 210y is displaced in a coordinated manner with the holder 120 along the first coordinate axis X of the XY plane for the constant, real time measurement of the Y position of the holder 120. Similarly, the coordinated displacement of both the holder 120 and the optical device 210y can be a synchronous displacement.

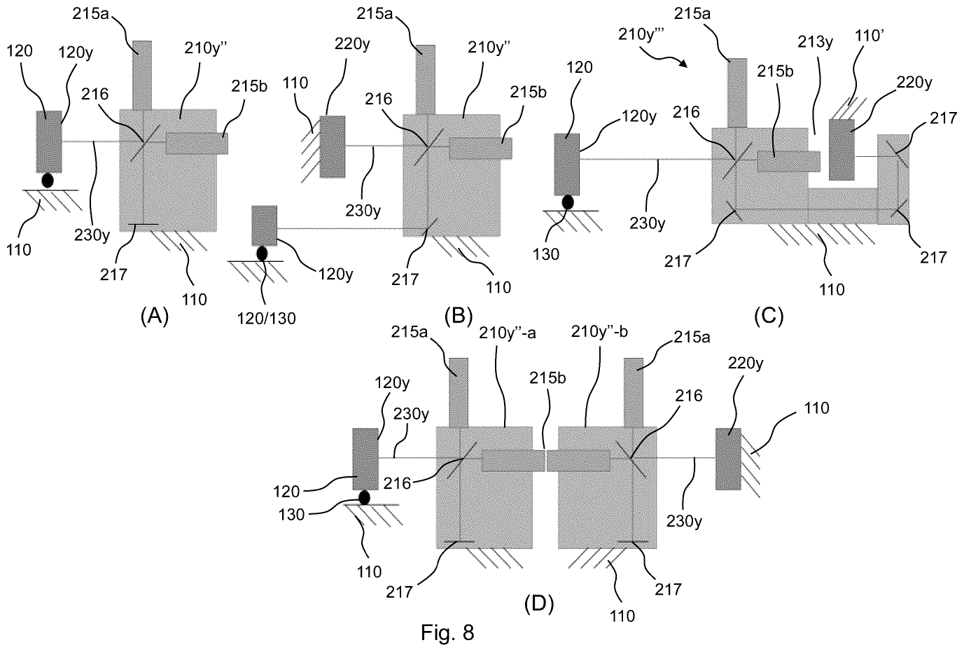

FIGS. 8A-8D disclose several examples according to the disclosure of the optics used in the optical device 210y. The optics of the optical device implement so-called “Michelson” interferometry optics. In FIG. 8A, the optical device 210y″ incorporates a laser light device 215b. The laser light device 215b emits a laser light beam 230y which is split by means of a beam splitter 216 and reflected via mirror 217 towards the first axis holder measuring mirror 120y mounted to the holder 120 (FIG. 8A). The reflected part of the laser beam light 230y is reflected back towards the “Michelson” interferometry optics and detected by the light detector 215a.

Similarly, as shown in the alternative example of the optical device 210y″ of FIG. 8B, the laser light device 215b emits the laser light beam 230y which is also split by the beam splitter 216 and reflected via mirror 217 towards both the first axis holder measuring mirror 120y mounted to the holder 120 towards the measuring mirror 220y mounted to the frame 110. Parts of the laser beam light 230y from both mirrors 120y and 220y are reflected back towards the “Michelson” interferometry optics and detected by the light detector 215a.

The example of FIG. 8C shows the optical device 210y″ having a similar configuration as the optical device 210y′ of FIG. 5C. Also this example implements “Michelson” interferometry optics and emits laser light beam 230y with the laser light device 215b. Beam splitter 216 and several mirrors 217 direct the laser light beam 230y towards both the first axis holder measuring mirror 120y mounted to the holder 120 and the measuring mirror 220y mounted to the support part 110′ of the frame 110, which measuring mirror 220y reaches into a recess 213y in the mount 212y of the optical device 210y″. The reflected part of the laser beam light 230y is reflected back towards the “Michelson” interferometry optics and detected by the light detector 215a.

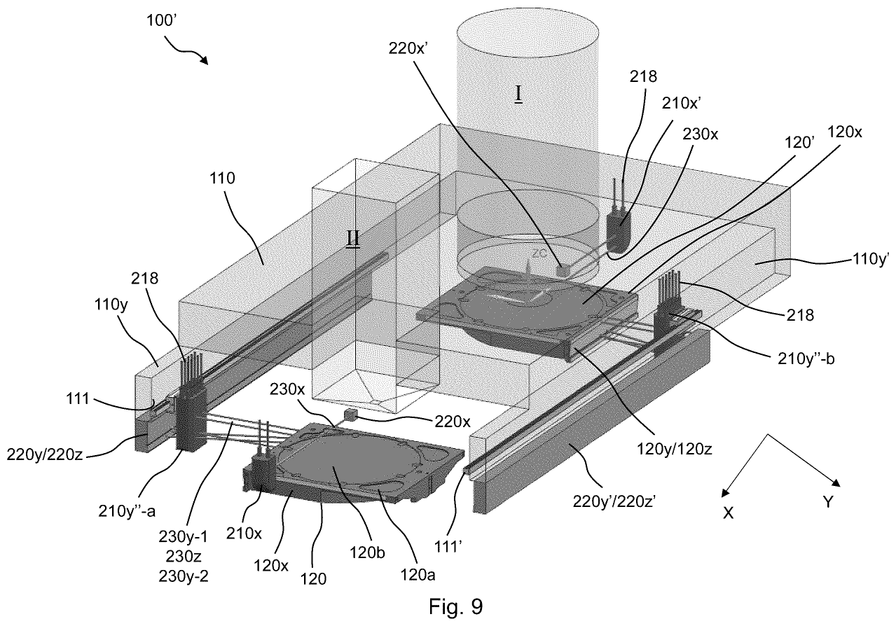

The example of FIG. 8D should be regarded with the example of FIG. 9. Both example depicts two optical devices 210y″-a and 210y″-b displaceable mounted to the frame 110 e.g. via separate guide parts 110y-110y′ and guide rails 111-111′. They both implement a laser light device 215b, a beam splitter 216 and a mirror 217 direct the laser light beam 230y towards either the first axis holder measuring mirror 120y mounted to separate holders 120-120′ and the measuring mirrors 220y/220z-220y′/220z′ mounted to the frame 110. The reflected parts of the reflected laser beams 230y (in FIG. 9 the three laser light beams 230y-1, 230y-2 and 230z) are detected by the respective light detector 215a of the two optical devices 210y″-a and 210y″-b.

FIG. 9 depicts a position measurement system 100′ allowing the monitoring of the position of two holders 120-120′ within the XYZ coordinate system during their independent displacement within the system working space between the first operational position I and the second operational position II. For accurately monitoring both positions of the holders 120-120′ the frame 110 is provided with two measuring mirrors 220y/220z-220y′/220z′ which are mounted at opposite positions relative to the first coordinate axis (X) in the frame 110, alternatively to respective guide parts 110y-110y′. The two first axis optical devices 210y″-a and 210y″-b are equally displaceable along the first coordinate axis X and their respective measuring mirror 220y/220z-220y′/220z′ by means of the guide rail 111-111′ as clarified earlier. The first axis optical devices 210y″-a and 210y″-b measure the Y position and Z position as well as any tilting position Rx of the respective holder 120-120′ within the XYZ coordinate system (the system working space).

Similarly, for measuring the X position of each holder 120-120′, second axis optical devices 210x-210x′ are implemented which emit corresponding laser light beams 230x towards corresponding second axis (X) measuring mirrors 220x-220x′.

In all examples shown, the electric laser light interferometry measuring signals generated by the first axis optical devices 210y and second axis optical devices 210x and which signals comprise at least information as to the X, Y and Z position of the holder 120/120′ within the XYZ coordinate system are processed via proper signal wiring 218 (see e.g. FIGS. 4A-4B, 7A-7B and 9).

In all examples of FIGS. 8A-8D, when using laser interferometry the proper Y position of the holder 120 relative to the first coordinate axis X can be determined based in the reflected laser light 230y. With one laser light device 215b and light detector 215a a differential sensing device is obtained, wherein the measuring mirror 220y should be illuminated from the same side as the first axis holder measuring mirror 120y on the holder 120 in order to be insensitive for (Y) displacements of the optical device(s).

### LIST OF REFERENCE NUMERALS

I/II/III first/second/third operational position
10 position detection system according to the prior art
11 frame/solid world
12 holder
12a XY mounting surface of holder 12
12b mounting space of holder 12
13 holder displacement means of holder 12
14 object
21x second axis (X) optical device (state of the art)
21y-a/b first/second first axis (Y) optical device (state of the art)
22x-a/b first/second second axis (X) measuring mirror (state of the art)
23x second axis (X) laser light beam (state of the art)
100-100′ position detection system (first/second example according to the disclosure)
110 frame/solid world
110′ support part of frame 110
110y guide part of frame 110
111 guide rail of guide part of frame 110
120 holder
120a XY mounting surface of holder 120
120b mounting space of holder 120
120y first axis (Y) holder measuring mirror of holder 120
120y-1/2 (first/second) mirror face of first axis (Y) holder measuring mirror
120z third (Z) axis holder measuring mirror of holder 120
120z-1 further mirror face of third axis (Z) holder measuring mirror
130 holder displacement means of holder 120
140 object
210x second axis (X) optical device
210y (“-”) first axis (Y) optical device (first, second, third example)
211y device displacement means of first axis (Y) optical device 210y
212y mount or housing of first axis (Y) optical device 210y
213y recess in mount 212y
215-a/b (first/second) laser device
216 interferometer optics
217 reflection mirror
218 signal wiring
220x second axis (X) measuring mirror (according to the disclosure)
220y first axis (Y) measuring mirror (according to the disclosure)
220y-1 mirror face of first axis (Y) measuring mirror
220z third axis (Z) measuring mirror (according to the disclosure)
220z-1 mirror face of third axis (Y) measuring mirror
230x X laser light beam (according to the disclosure)
230y-1/2 (first/second) Y laser light beam (according to the disclosure)
230z Z laser light beam (according to the disclosure)

1. A position detection system using laser light interferometry for measuring the positions and displacements of an object relative to and within an XYZ system of coordinates, the system comprising:
frame;
a holder comprising a mounting surface for the object, the mounting surface being oriented in the XY plane of the XYZ system of coordinates, wherein the holder is structured to be displaced at least between a first operational position and a second operational position within the XY plane relative to the frame;
several measuring mirrors as well as a plurality of optical devices, each optical device structured to emit and direct a respective laser light beam to and from a respective measuring mirror and structured to detect and convert at least part of the respective laser light beams reflected by the respective measuring mirrors into electric measuring signals, the electric measuring signals comprising at least information as to the X, Y and Z position of the holder,
wherein, for measuring the position of the holder relative to a first coordinate axis of the XY plane, at least one first axis optical device is structured to be displaced with the holder between the first operational position and the second operational position along the first coordinate axis of the XY plane and is structured to emit and direct a respective first laser light beam parallel to the XY plane and perpendicular to the first coordinate axis to and from a first mirror face of a respective first axis measuring mirror extending along the first coordinate axis beyond both the first operational position and the second operational position.

2. The position detection system according to claim 1, wherein the at least one first axis optical device is mounted to the holder.

3. The position detection system according to claim 1, wherein the at least one first axis optical device is mounted to a mount structured to be displaced between the first operational position and the second operational position along the first coordinate axis relative to the frame.

4. The position detection system according to claim 1, wherein the first axis measuring mirror is mounted to the frame.

5. The position detection system according to claim 4, wherein the first axis measuring mirror is composed of at least two first axis measuring submirrors.

6. The position detection system according to claim 3, wherein the mount is provided with a recess for receiving the first axis measuring mirror.

7. The position detection system according to claim 1, wherein, for measuring the position of the holder relative to the first coordinate axis of the XY plane, the holder comprises a first axis holder measuring mirror having at least a first mirror face positioned perpendicular to the XY plane.

8. The position detection system according to claim 1, wherein, for measuring a Z position of the holder relative to the XY plane, the at least one first axis optical device is structured to emit and direct a respective further laser light beam under an angle α relative to the XY plane to and from a further mirror face of the first axis measuring mirror.

9. The position detection system according to claim 8, wherein, for measuring the Z position of the holder relative to the XY plane, the at least one first axis optical device is structured to emit and direct the respective further laser light beam under the angle α relative to the XY plane to and from a further mirror face of the first axis holder measuring mirror.

10. The position detection system according to claim 8, wherein the further mirror face of the first axis measuring mirror or the first axis holder measuring mirror is orientated at the angle α relative to the first mirror face of the first axis measuring mirror or the first axis holder measuring mirror.

11. The position detection system according to claim 8, wherein the angle α is in the range between 5°-45°, in particular in the range of 5°-25°, more in particular in the range of 5°-15°, and more in particular the angle α=7°.

12. The position detection system according to claim 8, wherein the first axis holder measuring mirror may comprise a third mirror face positioned perpendicular to the XY plane and adjoining the further mirror face opposite the first mirror face.

13. The position detection system according to claim 1, wherein, for measuring the position of the holder relative to the second coordinate axis of the XY plane, the system comprises a further second axis optical device structured to emit and direct a respective laser light beam parallel to the XY plane and parallel to the first coordinate axis to and from at least one second measuring mirror positioned perpendicular to the first coordinate axis of the XY plane and positioned beyond the first operational position or the second operational position.

14. The position detection system according to claim 13, wherein a further second measuring mirror is positioned perpendicular to the first coordinate axis of the XY plane and positioned between the first operational position or the second operational position.
